(19) United States
(12) Patent Application Publication
(10) Pub. No.: US 2009/0030599 A1
(43) Pub. Date: Jan. 29, 2009

(54) Navigation apparatuses, methods, and programs

(75) Inventor: Hiroshi Kawauchi, Kariya (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-shi (JP)

(21) Appl. No.: 12/216,778

(22) Filed: Jul. 10, 2008

(30) Foreign Application Priority Data
Jul. 27, 2007 (JP) 2007-195499
Mar. 28, 2008 (JP) 2008-086458

(51) Int. Cl. G01C 21/00

(52) U.S. Cl. 701/200

(57) ABSTRACT

Navigation apparatuses, methods, and programs store a plurality of destinations, each destination being associated with a plurality of types of search items. The apparatuses, methods, and programs input a first search character and retrieve the destinations in which the input search character exists in one of the associated search items. The apparatuses, methods, and programs temporarily store the retrieved destinations in association with the search item in which the input character exists. The apparatuses, methods, and programs input a second search character and narrow down the temporarily stored destinations by deleting the temporarily stored destinations in which the second search character does not exist in any of the associated search items. The apparatuses, methods, and programs display the narrowed down destinations as candidate destinations, permit selection of one of the displayed candidate destinations, and provide route guidance to the selected destination.

### INCORPORATION BY REFERENCE

The disclosures of Japanese Patent Application No. 2008-086458, filed on Mar. 28, 2008, and Japanese Patent Application No. 2007-195499, filed Jul. 27, 2008, including the specifications, drawings, and abstracts thereof, are incorporated herein by reference in their entirety.

### BACKGROUND

1. Related Technical Fields

Related technical fields include a navigation apparatuses, methods, and programs having a capability of performing a search according to an input character string.

2. Related Art

In recent years, it has become very popular to use a navigation apparatus to guide a vehicle. Such navigation apparatuses search for a route from a start point to a destination, detect a vehicle position by using GPS (Global Positioning System) satellites and/or a sensor such as a gyroscope sensor, and display the route to the destination and the current vehicle position on a map. In general, in a navigation apparatus, destination data includes a plurality of items such as names, types, and addresses. If a location name, a building name, an address, a telephone number, and/or the like of a destination are input via a touch panel, candidate destinations are narrowed down according to the input data. When the search according to the input information such as the name or the type is completed, extracted candidate destinations are displayed in the form of a list so that a user can select one of the candidate destinations. An example of such a navigation apparatus may be found, for example, in Japanese Unexamined Patent Application Publication No. 11-271084.

### SUMMARY

In the navigation apparatus described above, the destination search is performed according to an input destination name, a type, and/or an address. In the search process, a user must specify whether the search is to be performed by name, type, or address. For example, if “Tokyo” is simply input without specifying the item for which the search is to be performed, it is difficult to determine whether “Tokyo” is a part of a destination name or a part of an address.

When searching based on, for example, a name, it is possible to further narrow down candidates by selecting a type or further inputting an address. However, the name search, the type search, and the address search have their own different search screen. Therefore, to further narrow down the candidates according to a particular item, it is necessary to switch the search screen corresponding to the item. Thus, a user has to perform a troublesome operation in the search.

Exemplary implementations of the broad inventive principles described herein provide a technique to efficiently input data necessary in searching for a destination without having to change the, screen depending on the search item such as the type, the name, etc.

Exemplary implementations provide apparatuses, methods, and programs store a plurality of destinations, each destination being associated with a plurality of types of search items. The apparatuses, methods, and programs input a first search character and retrieve the destinations in which the input search character exists in one of the associated search items. The apparatuses, methods, and programs temporarily store the retrieved destinations in association with the search item in which the input character exists. The apparatuses, methods, and programs input a second search character and narrow down the temporarily stored destinations by deleting the temporarily stored destinations in which the second search character does not exist in any of the associated search items. The apparatuses, methods, and programs display the narrowed down destinations as candidate destinations, permit selection of one of the displayed candidate destinations, and provide route guidance to the selected destination.

According to exemplary implementations, the apparatuses, methods, and programs store at least one keyword for each search item and extract keywords including the input first search character for each of the plurality of search items. The apparatuses, methods, and programs display one or more extracted keywords and permit selection of a displayed keyword. If a keyword is selected, the apparatuses, methods, and programs narrow down the temporarily stored destinations by deleting the temporarily stored destinations in which the selected keyword does not exist in any of the associated search items.

### BRIEF DESCRIPTION OF THE DRAWINGS

Exemplary implementations will now be described with reference to the accompanying drawings, wherein:

FIG. 1 is a block diagram illustrating a system configuration of an exemplary navigation apparatus;

FIG. 2 is a diagram illustrating an example of content of destination data (location information) stored in a destination data file;

FIG. 3 is a diagram illustrating examples of keywords stored in a keyword data file;

FIG. 4 is a schematic diagram illustrating an exemplary input apparatus and display;

FIG. 5 is a flow chart illustrating an exemplary destination setting method;

FIG. 6 is a flow chart illustrating an exemplary method of displaying keywords in the form of keys;

FIGS. 7A to 7H are schematic diagrams illustrating an example of a destination setting screen in various states;

FIG. 8 is a diagram illustrating an example of content of destination data (location information) stored in a destination data file in an exemplary navigation apparatus designed for use in English;

FIGS. 9A and 9B is a diagram illustrating examples of keywords stored in a keyword data file in an exemplary navigation apparatus designed for use in English;

FIG. 10 is a schematic diagram illustrating an input apparatus and a display of an exemplary navigation apparatus designed for use in the USA; and

FIGS. 11A to 11H are schematic diagrams illustrating an example of a destination setting screen in various states in an exemplary navigation apparatus designed for use with English.

### DETAILED DESCRIPTION OF EXEMPLARY IMPLEMENTATIONS

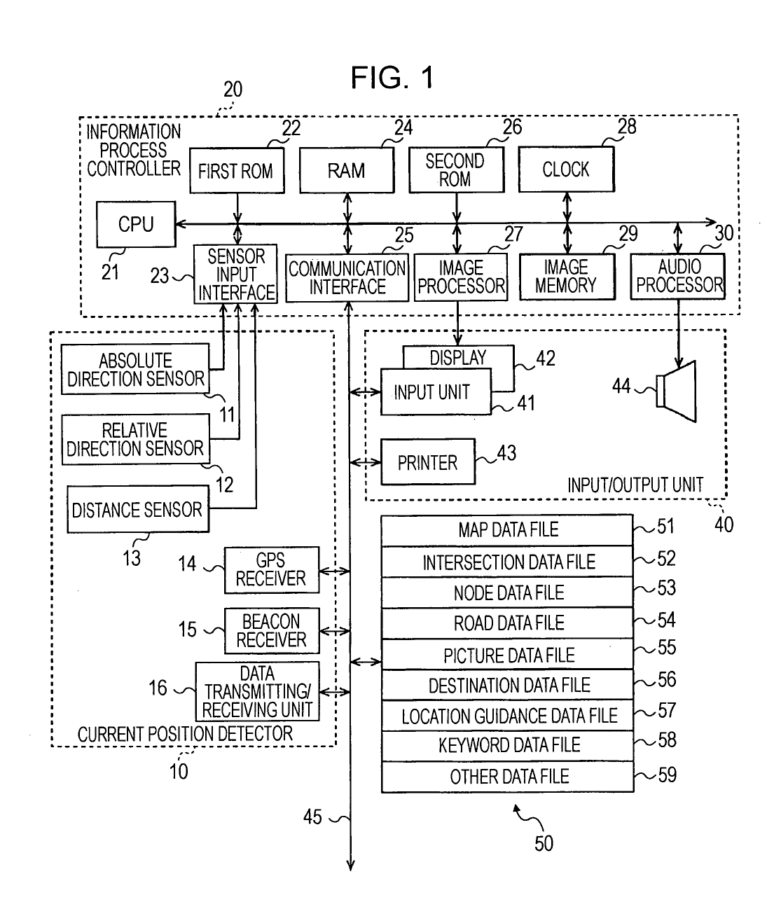

Examples of navigation apparatuses, methods, and programs will be described below with reference to FIGS. 1 to 11H. FIG. 1 is a block diagram illustrating an exemplary configuration of a navigation apparatus. This navigation apparatus is designed to be installed in a vehicle, and includes, as shown in FIG. 1, a current position detector 10, an information process controller 20, an input/output unit 40, and an information storage unit 50.

The current position detector 10 is configured as follows. An absolute direction sensor 11 is, for example, a geomagnetic sensor for detecting the direction of the vehicle based on the north direction indicated by a magnetic needle. Note that the absolute direction sensor 11 is not limited to the geomagnetic sensor, but other direction sensors may be used as long as the absolute direction can be detected.

A relative direction sensor 12 is used, for example, to detect a turning movement at an intersection or the like. The relative direction sensor 12 may be implemented, for example, by an optical rotation sensor or a rotating variable resistor disposed on a rotating part of a steering wheel, or an angle sensor disposed on a wheel. Alternatively, a gyroscope sensor adapted to detect a change in angle based on an angular velocity or any other sensor may be used as long as it is possible to detect a change in angle with respect to a reference angle (absolute direction). A distance sensor 13 is a sensor adapted to detect a distance by detecting the rotation of a wheel or by integrating the acceleration twice. Alternatively, any other sensor may be used as long as it is possible to detect a distance traveled by the vehicle.

A GPS receiver 14 is a unit adapted to receive signals from satellites to acquire various kinds of information such as a signal transmission time, the position of the receiver, the moving speed of the receiver, the direction in which the receiver is moving, etc. A beacon receiver 15 is a unit adapted to receive signals transmitted from transmitters disposed at particular locations. In particular, the beacon receiver 15 is adapted to acquire VICS® (Vehicle Information and Communication System) information indicating traffic/vehicle information such as congestion information, current position information, parking lot information, etc.

A data transmitting/receiving unit 16 is a unit adapted to communicate with an external apparatus via a telephone line or a radio wave to obtain information. The data transmitting/receiving unit 16 can be used for various purposes such as a mobile telephone, ATIS (Advanced Traffic Information Service), VICS, GPS correction, intervehicle communication, etc., whereby it is possible to obtain/provide information about the vehicle running. The information process controller 20 is a unit adapted to perform calculations and control in accordance with information supplied from the current position detector 10 or the input/output unit 40 and/or information stored in the information storage unit 50. The result of the calculation is supplied to an output unit such as a display 42, printer 43 and/or a speaker 44.

The information process controller 20 is configured as follows. A controller, (e.g., central processing unit (CPU) 21) is a unit responsible for integrated control of various operations of the navigation apparatus. A first ROM 22 stores a navigation program to detect the current position, search for a route, and provide navigation guidance. A sensor input interface 23 is a unit adapted to receive information from the current position detector 10.

A RAM 24 stores information input via an input apparatus 41 such as information associated with a destination, passing points, etc., information indicating a result of a calculation performed by the CPU 21 in accordance with information input by a user, information indicating a result of route search, map information read from the information storage unit 50, etc. A communication interface 25 is a unit adapted to input/output information from/to the current position detector 10, and more particularly information obtained from the outside.

A second ROM 26 stores a program associated with navigation and more particularly a program associated with voice guidance. An image processor 27 is a unit adapted to convert vector information supplied from the CPU 21 into image information. A clock 28 is a unit adapted to provide time information. An image memory 29 stores image information obtained as a result of the process performed by the image processor 27. An audio processor 30 is adapted to process audio information read from the information storage unit 50 and supply a result to the speaker 44.

The input/output unit 40 includes the input apparatus 41 used by a user to input data indicating a destination, a passing point, a search condition, etc., the display 42 for displaying an image, the printer 43 for printing information, and the speaker 44 for outputting a voice/sound. The input apparatus 41 is implemented, for example, by a touch panel disposed on the surface of the display 42, a touch switch, a joystick, or a key switch. The display 42 is adapted to display a map of an area around the current position, various kinds of operation screen, and a travel route to the destination.

The information storage unit 50 is connected to the information process controller 20 via a transmission line 45. The data/information stored in the information storage unit 50 includes a map data file 51, an intersection data file 52, a node data file 53, a road data file 54, a picture data file 55, a destination data file 56, a location guidance data file 57, a keyword data file 58, and an other-information data file 59. The information storage unit 50 is generally implemented by a memory such as an optical storage medium such as a DVD-ROM or a CD-ROM or a magnetic storage medium such as a hard disk. Alternatively, other information storage media such as a magneto-optical disk or a semiconductor memory may be used.

The map data file 51, stores map data such as a road map of a whole country, road maps of respective areas, a house map, etc. Each road map includes various types of roads such as main highways, expressways, and narrow roads, and landmarks (facilities). The house map includes data representing outlines of buildings/houses and data indicating road names and the like. The narrow roads are roads that are smaller in width than national roads or prefectural roads, and which have no traffic control information.

The intersection data file 52 stores data associated with intersections such as data indicating geographical position coordinates, data indicating intersection name, etc. The node data file 53 stores geographic coordinate data of each node used in searching for a route on a map. The road data file 54 stores data indicating positions, types, and the number of lanes or each road and data indicating connections between roads. The picture data file 55 stores image data of various landmarks, sightseeing spots, main intersections, etc., to be used to provide visual information. The destination data file 56 stores data about various landmarks, sightseeing spots, facilities, companies (which may be listed in a telephone directory), etc., selectable as the destination. The location guidance data file 57 stores guidance data of various places, such as contents of guide signs disposed on roads, guidance of branch points, etc.

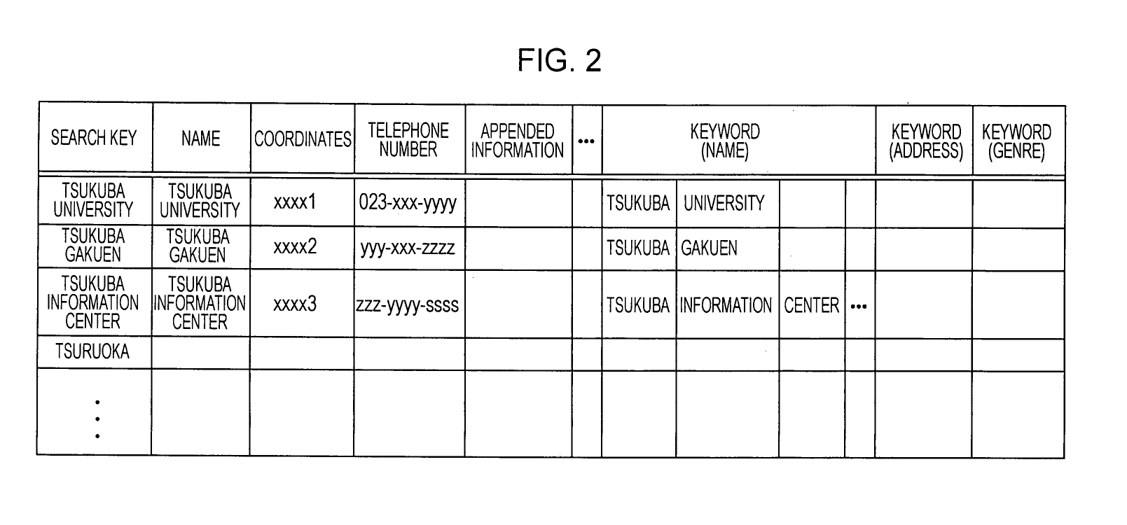

FIG. 2 is a diagram illustrating an example of content of destination data (location information) stored in the destination data file 56. As shown in FIG. 2, according to the present example, destination data includes search keys, names, coordinates, telephone numbers, appended information, and keywords. In the case of a navigation apparatus for use with Japanese, each search key is a string of phonetic characters (kana characters) indicating a “name” of a destination. In the present example, the input apparatus 41 is implemented using Japanese syllabary keys adapted to input search keys expressed in kana characters. The coordinates are (x, y) coordinate information indicating the latitude and the longitude of each destination. The appended information is detailed data associated with each destination.

The keywords are stored for each search item (the name, the address, and the type) distinguished from each other. Each destination is assigned keywords of each item. For example, as for keywords associated with names, a destination “Tsukuba University” is assigned keywords “Tsukuba” and “University,” and a destination “Kakudonal Tokyo Station Store” is assigned keywords “Kakudonal,” “Tokyo Station,” etc. Similarly, keywords of the other items, i.e., the address and the type are stored for each destination. The type is a hierarchical classification of each destination, such as “restaurant,” “shopping/renting” “hotels,” “sightseeing,” and “vehicle-related facilities.” The type of “shopping/renting” includes, at lower levels thereof, “convenience stores,” “supermarkets,” “discount stores,” “department stores,” etc. Each destination is defined in advance to belong to one of the types, and data indicating the type is stored.

If there is a short form or an alias for a destination, destination data may include such a short form or an alias may be employed as a keyword, even if the short form or the alias is not included in the name thereof. For example, when a destination name “Game Center Kogami Head office” is also called “GaCen” in short, “GaCen” may be employed as a keyword in addition to “Game Center,” “Kogami,” and “Head Office.”

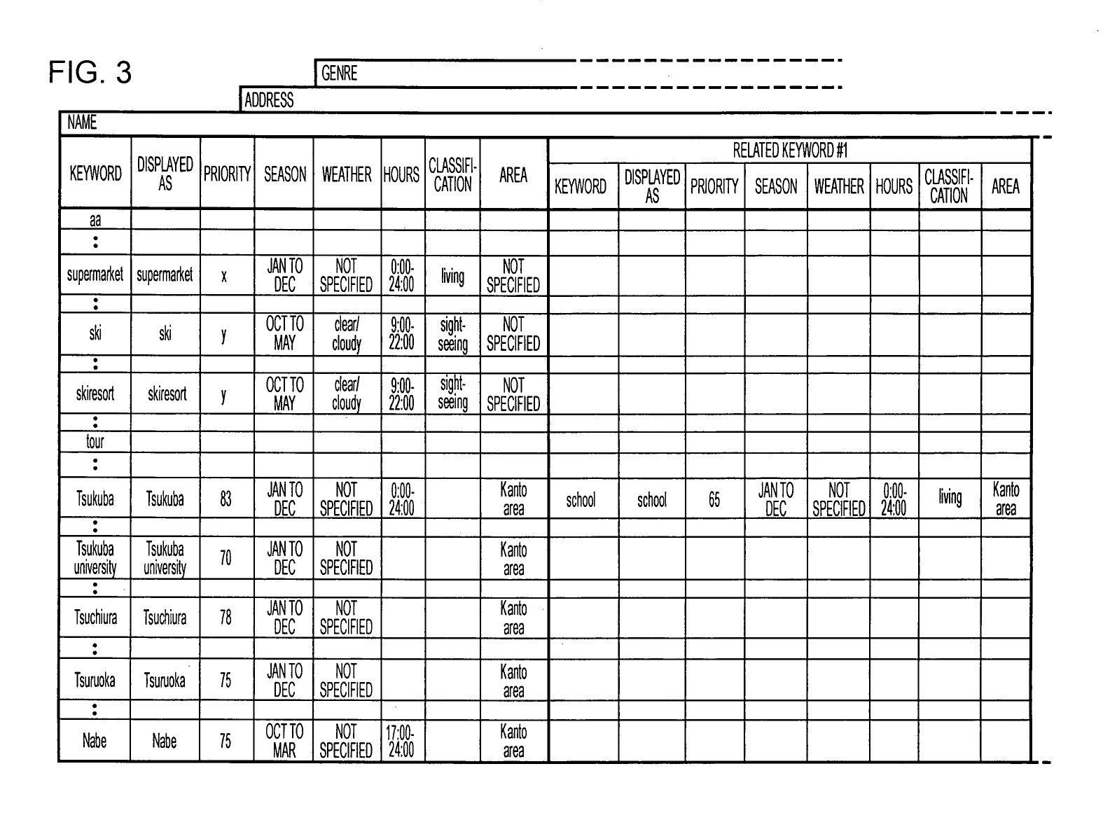

In the keyword data file 58 shown in FIG. 1, keywords are stored that are searched according to input characters. FIG. 3 shows examples of keywords stored in the keyword data file 58. As shown in FIG. 3, in the keyword data file 58, as in the destination data file 56, keywords of respective search items, i.e., name keywords, address keywords, and type keywords are stored. Each keyword data includes a word (spelling) and a phonetic expression (kana expression) indicating a corresponding destination of destination data. A keyword is produced by extracting a word from the name or the address of each destination. In addition, for example, a short form or an alias such as “convenie” for “convenience store” or “GaCen” for “game center” may also be employed as a keyword, if such an expression is actually used.

In the present example, as described in further detail later, spellings of keywords are extracted based on an input string of phonetic characters, and resultant keywords are displayed in the form of input keys. Each keyword is assigned priority. The keywords obtained as a result of the narrowing down according to the input character string are displayed in the order according to the priorities assigned to the respective keywords. The priority is changed according to current conditions in terms of time, location, etc. Specifically, the priority is changed according to a season, weather, a time zone, etc. in which a destination is available, and according to the type of the destination, an area where the destination is located, etc. Each keyword has data defining the conditions according to which to change the priority, for each item. For example, candidate destinations including a “Nabe” in keyword are assigned priority of “75,” and defined as being available in a season from “October to March” Therefore, if the current time is within this period, a predetermined value (for example, 3) is added to the normal priority “75,” and thus the priority is changed to “78.”

For some keywords, related keywords are defined. A word having a high probability of being input together with a keyword is employed as a related keyword for this keyword. For example, when “Gakuen” and “Center” are part of the name of a destination having an assigned keyword “Tsukuba,” “Gakuen” and “Center” are employed as related keywords.

In the present example, when a user selects one of the keywords obtained as a result of the narrowing-down according to an input character string, related keywords associated with the selected keyword are displayed as next selection candidates (input candidates) in the form of keys. Related keywords are also displayed in addition to keywords in a case where the total number of keywords obtained as a result of the narrowing-down for an input character string is smaller than a predetermined number (for example, a maximum number of keywords which can be displayed on the display screen at a time). As shown in FIG. 3, for each related keyword, as with the keywords, the priority, the conditions according to which to change the priority such as the season, the weather, the time zone, etc, in which a destination is available, the type, the area, etc., are defined as required. The related keywords are stored as keywords in each corresponding destination data, and thus the related keywords are treated in the same manner as the keywords.

In the present example, keywords and related keywords are employed as words that should be met in the logical AND operation in narrowing down the candidate destinations. For example, when both a keyword A and a related keyword B are selected, destination data having both keywords A and B are extracted. Similarly, the logical AND operation is performed among keywords and related keywords of the respective items of name, address, and type in narrowing down the destination data.

The navigation apparatus configured in the above-described manner provides route guidance as follows. The navigation apparatus detects the current position using the current position detector 10, reads map information of an area around the detected current position from the map data file 51 stored in the information storage unit 50, and displays the map on the display 42. If a destination is set via a destination setting process, which will be described later, the information process controller 20 searches for a plurality of routes from the current position to the specified destination and displays the plurality of routes on the map on the display 42. If a driver selects one of the routes, the information process controller 20 stores the selected travel route in the RAM 24 thereby acquiring the travel route.

The information process controller 20 may transmit data indicating the vehicle current position (or an input starting point) and the destination to an information processing center and may receive data indicating a route to the destination from the information processing center thereby acquiring the travel route. In this case, the data indicating the destination or the travel route is wirelessly transmitted via a communication interface 25.

If the vehicle starts running, the current position is monitored using the current position detector 10, and route guidance is provided according to the detected current position. Specifically, the route guidance is provided as follows. The vehicle position on the map is determined according to map matching between road data corresponding to the detected travel route and the current position detected by the current position detector 10. The map around the detected current position is displayed on the display 42, and the travel route and the current position are displayed on this map. Thereafter, a determination is made repeatedly according to the current position on the planned travel route as to whether any guidance should be provided. If it is determined that route guidance should be provided, route guidance is provided on the display 42 or via voice. For example, information is provided to inform the driver that the driver should drive the vehicle straight a particular distance, should make a turn at a particular point, etc., or information indicating a direction in which to drive the vehicle is provided.

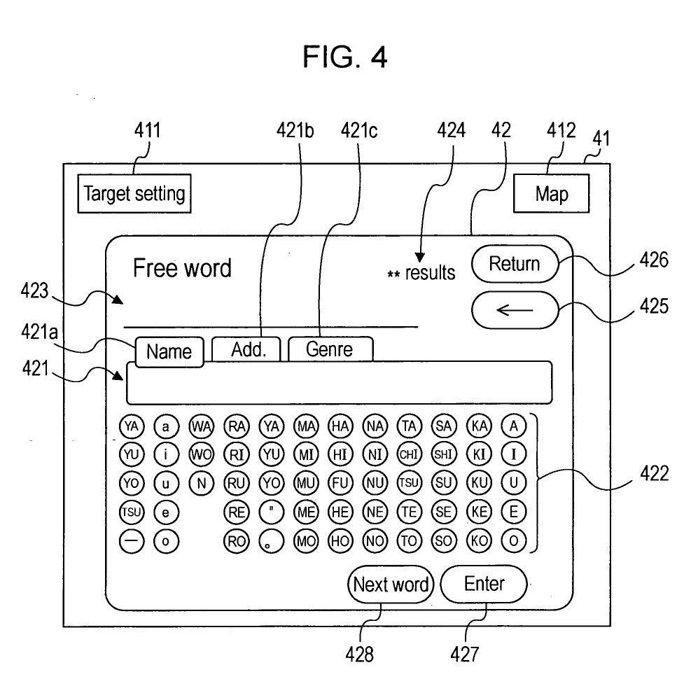

Next, the destination setting process according to the present example is explained. FIG. 4 illustrates the input apparatus 41 and the display 42. As shown in FIG. 4, a destination setting screen, a map around the current position, and other various kinds of menu screens are displayed on the display 42. The display has a touch panel disposed on the display screen thereof whereby a user is allowed to perform selection by directly touching the touch panel with a finger. A fixed frame of the input apparatus 41 is disposed around the external edge of the display 42. In an upper area of the fixed frame, disposed are a destination setting key 411 implemented by a physical push button (hard key), and a map key 412 used to display a map screen of an area around the current position.

The destination setting key 411 is a key used to display the destination setting screen for setting a destination, a passing point, and the like. If this destination setting key 411 is selected, the destination setting process according to the present example is performed. The destination set via the destination setting process according to the present example is used when the route search is performed and also when the determined destination or destination candidates in an area around the current position are displayed on the map screen.

The specific example of the display 42 shown in FIG. 4 is in a state in which the destination setting screen is displayed thereon. The destination setting screen includes a keyword field 421, an input keyboard 422, an input character field 423, a number-of-candidates field 424, a back key 425, a return key 426, an enter key 427, and a next word key 428. The keyword field 421 is a field in which keywords (including related keywords) narrowed down according to an input character string are displayed. Note that in the keyword field 421, the keywords are displayed in the form of input keys. If any input key is touched, a keyword corresponding to the touched input key is selected. Keywords and related keywords are displayed in a distinguishable manner. Note that actually there are a plurality of keyword fields 421 for displaying name keywords, address keywords, and type keywords, which can be selected by selecting a name tab 421a, and address tab 421b, and a type tab 421c, respectively. If a tab is selected, a keyword field 421 corresponding to the selected tab is displayed in a highest level, and keywords are displayed in this keyword field 421. In the present example, when there is no destination data obtained as a result of the narrowing down according to the search character string and the keyword, a corresponding tab (which is one of the tabs 421a to 421c) is brought into a selection disabled state. If a tab is brought into the selection disabled state, the tab is deleted or displayed with a low intensity in order to explicitly indicate the fact that the tab is in the selection disabled state.

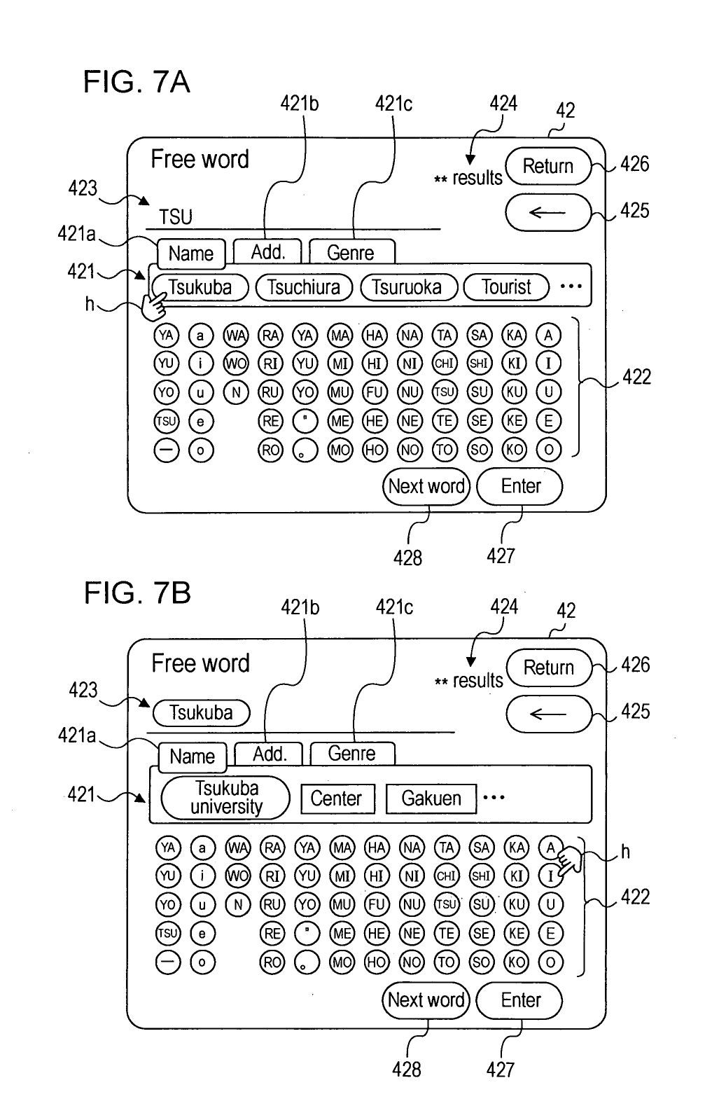

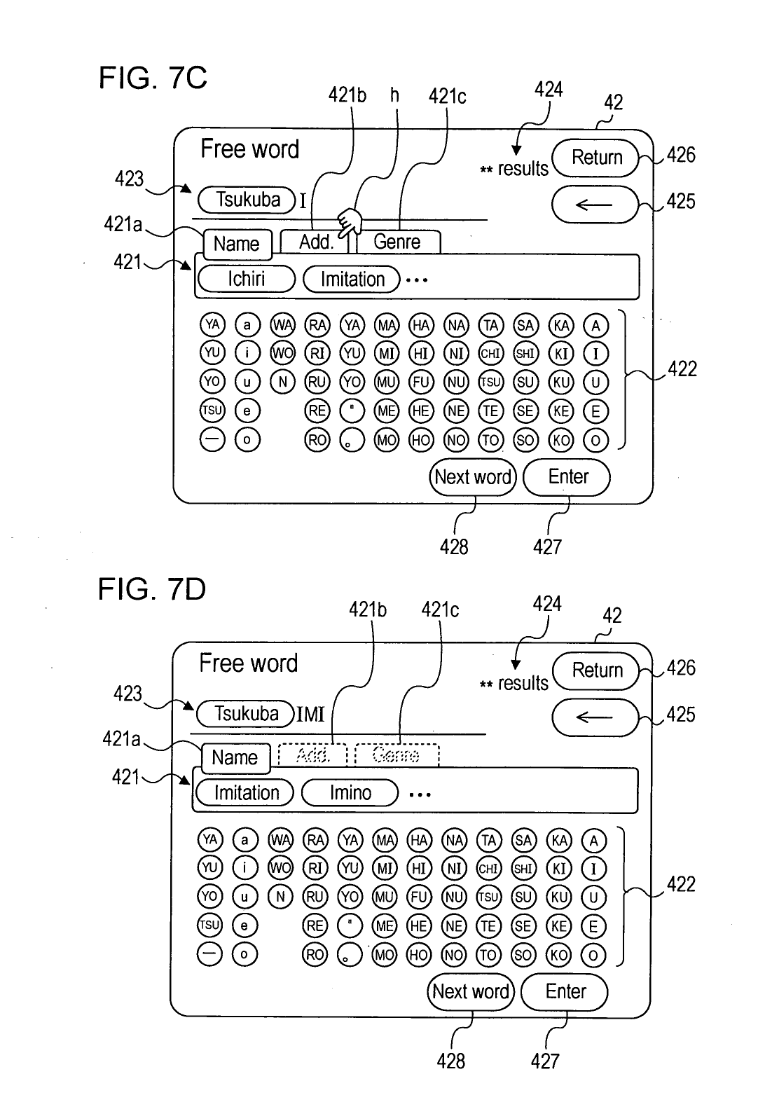

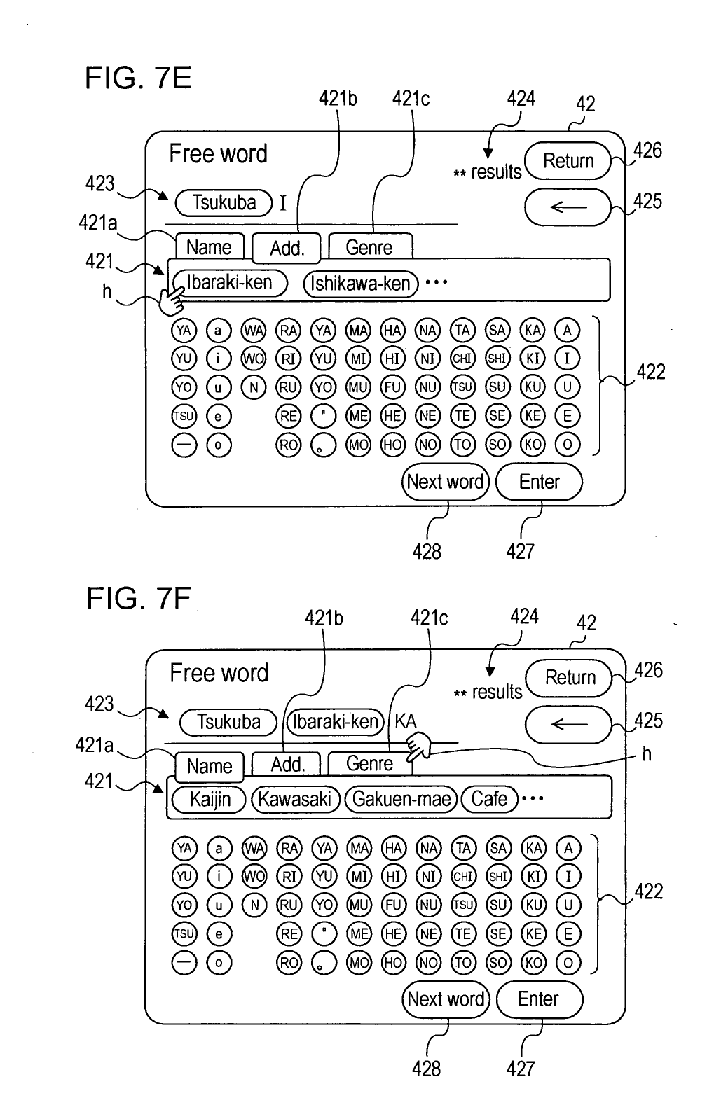

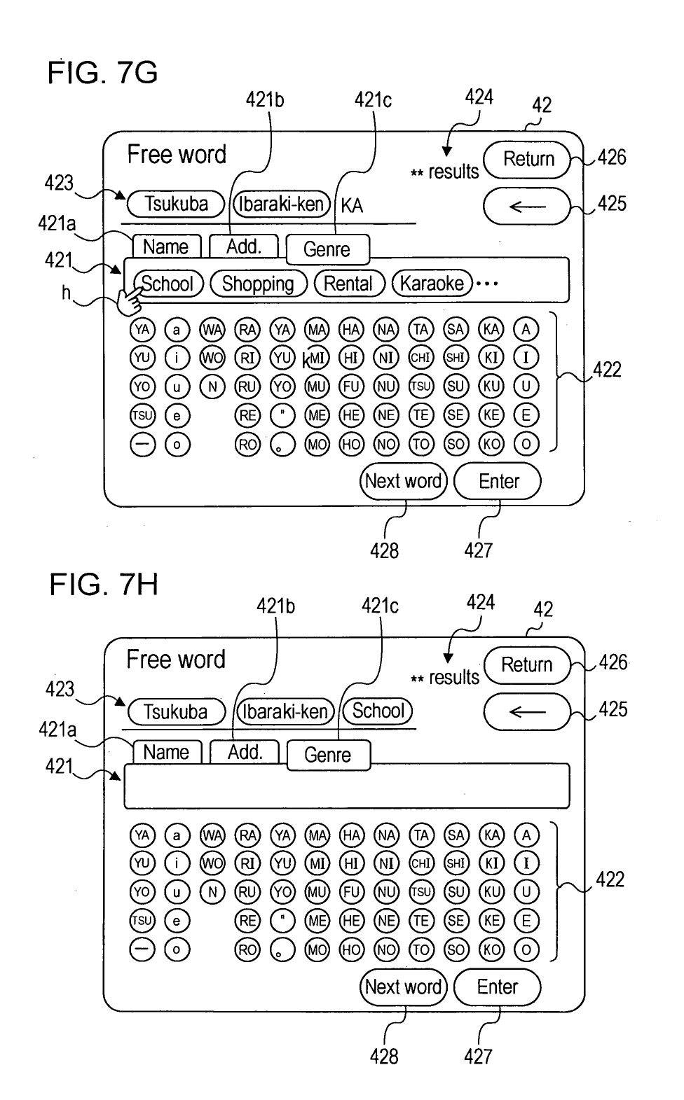

The input keyboard 422 includes a plurality of keys for inputting characters. In the case of the version for use in Japanese, the input keyboard 422 is configured so as to be capable of inputting Japanese phonetic characters, i.e., kana characters. Although the input keyboard 422 shown in FIG. 4 and FIGS. 7A to 7H include keys each labeled a Roman character, each actual key is labeled a Japanese kana character, and characters displayed in the input character field 423 are expressed in Japanese kana characters, while keywords displayed in the keyword field 421 are expressed in Japanese kanji characters or a combination of kanji characters and kana characters. The input keyboard 422 may additionally include numeric keys and/or function keys. The input character field 423 is a field in which characters input via the input keyboard 422 and a keyword selected in the keyword field 421 are displayed. The input characters and the keyword are displayed in a distinguishable manner. The number-of-candidates field 424 is a field in which to display the number of candidate destinations (destination data) extracted as a result of the narrowing down according to the input characters displayed in the input character field 423 or the keyword. The back key 425 is used when a correction is made for an input character or a selected keyword. The return key 426 is used to make a return to a state previous to a last operation. The enter key 427 is used to display candidate destination points obtained as a result of narrowing down based on input characters or a selected keyword.

The next word key 428 is used to complete the inputting of search characters. If this next word key 428 is pressed, characters already input and displayed in the input character field 423 are fixed and specified as a final complete search character string, and it becomes possible to start inputting another new search character string. That is, if the next word key 428 is pressed, no keywords displayed in the keyword field 421 are selected, and the narrowing down of candidate destination points is performed only based on the search characters. Specifically, when the next word key 428 is selected, destination data are narrowed down for each search item (the name, the address, and the type) using characters displayed in the input character field 423 as of when the next word key 428 is selected as search characters (excluding the selected keyword and other already fixed search character strings), and a logical OR (or AND) thereof is stored as a result of the narrowing down based on the search characters.

On the destination setting screen, as shown in FIG. 4, the input character field 423 is labeled “Free Word” to indicate that this input character field 423 can be used not only to simply input a destination name but also to freely input any keyword or related keyword.

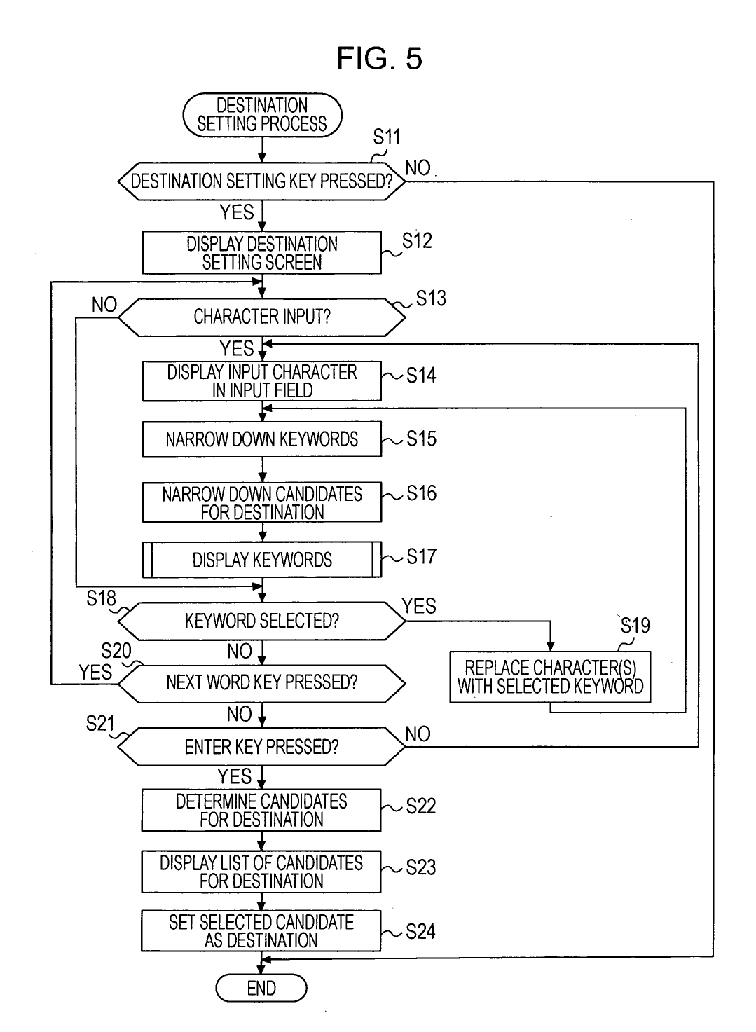

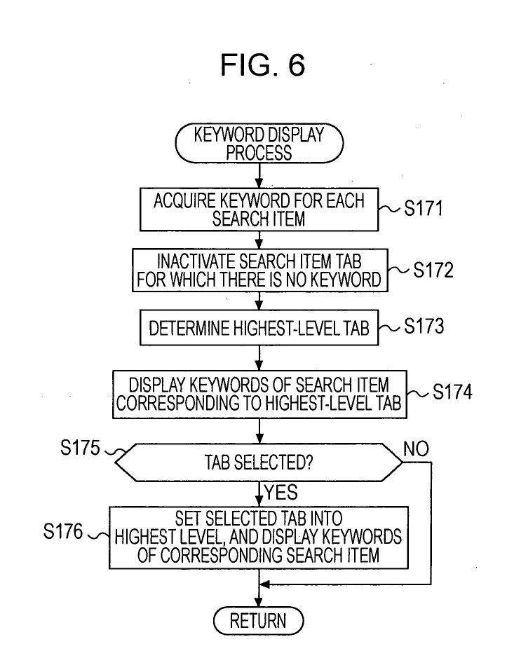

FIGS. 5 and 6 are flow charts illustrating an exemplary destination setting method. The exemplary method may be implemented, for example, by one or more components of the above-described navigation apparatus. For example, the exemplary method may be implemented by the CPU 21 and or information process controller 20 executing a computer program stored in the first ROM 22, second ROM 26, and/or the information storage unit 50. However, even though the exemplary structure of the above-described navigation apparatus may be referenced in the description, it should be appreciated that the structure is exemplary and the exemplary method need not be limited by any of the above-described exemplary structure.

For simplicity, the flow chart shown in FIG. 5 does not include a process that will be performed when the back key 425 or the return key 426 is pressed in the middle of the destination setting process. It is allowed to press the back key 425 or the return key 426 at any time before the enter key 427 is pressed. The back key 425 is used to correct an already input character, and the return key 426 is used to return to an immediately previous operation. These processes may be accomplished by routine programs.

As shown in FIG. 5, the information process controller 20 monitors whether the destination setting key 411 is selected by a user (step 11). If pressing of the destination setting key 411 is detected (Yes in step 11), the information process controller 20 displays a destination setting screen (e.g., shown in FIG. 4) (step 12), and the information process controller 20 monitors whether a character is input via the input keyboard 422 (step 13). If inputting of a character is detected (Yes in step 13), the information process controller 20 displays the input character in the input character field 423 (step 14), and the information process controller 20 extracts, from all keywords stored in the keyword data file 58, keywords that partially match the character (or character string) displayed in the input character field 423 (step 15). The keyword extraction is performed separately for the names, the addresses, and the types, and the extracted keywords are stored in predetermined storage areas of the RAM 24.

The information process controller 20 narrows down candidate destination points according to the input characters displayed in the input character field 423 and the keywords extracted as a result of the narrowing described above. The information process controller 20 stores the resultant candidate destination points in the RAM 24 and displays the number of candidate destination points in the number-of-candidates field 424 (step 16). The narrowing down of the candidate destination points based on the input characters is performed by determining search keys (readings of names, see FIG. 2) that partially match the input character(s) (one or more characters) displayed in the input character field 423. On the other hand, the narrowing down based on the keywords is performed by determining destination data including any one of the keywords obtained as a result of the narrowing performed in step 15. The set of destination data obtained as the result of the narrowing based on the input characters and the set of destination data obtained as the result of the narrowing based on the keywords are combined by performing the logical OR operation, and a resultant set of destination data included in any one of the data sets is stored as a result of narrowing down based on the input characters and the keywords (that is, as candidate destination points) in the RAM 24.

In the example described above, the narrowing down is performed by the logical OR operation. Alternatively, the narrowing down may be performed by the logical OR operation or a logical AND operation as specified by a user. In this case, destination data that include all selected keywords are extracted as a result as of the present stage of the narrowing process, and the result is stored in a particular storage area of the RAM 24.

At a stage where a first character of the search characters is input, the narrowing down of the candidate destination points is performed for the destination data file 56, and, in the narrowing process performed thereafter, the candidate destination points stored in the RAM 24 are further narrowed down. In the narrowing process performed on the candidate destination points stored in the RAM 24, candidate destination points that are not selected are deleted from the RAM 24. Instead of all destination data of candidate destination points obtained as a result of the narrowing down in the RAM 24, only IDs of the destination data may be stored in the RAM 24. In this case, the narrowing-down for the candidate destination points stored in the RAM 24 is performed while referring to the data stored in the destination data file 56 according to the IDs.

Next, the information process controller 20 performs a keyword key display process to display the keywords obtained as the result of the narrowing in the form of selectable keys in the keyword field 421 (step 17). FIG. 6 is a flow chart illustrating details of an exemplary method of displaying the keywords in the form of keys. As shown in FIG. 6, first, the information process controller 20 acquires keywords narrowed down in step 16 for each search item (step 171).

The information process controller 20 determines whether there is a search item having no keyword obtained as a result of the narrowing down (that is, a search item having no keyword corresponding to the input characters). If there is such a search item, a tab (one of the tabs 421a to 421c) corresponding to that search item is deleted (step 172). Specifically, the tab of the search item having no keyword corresponding to the input character(s) is deleted so as to explicitly indicate that the search item has no keyword, and thus disable the selection of this tab. Note that the deleting refers to explicitly indicating the fact that the search item has no keyword, and the corresponding tab may or may not be completely deleted as long as the fact is explicitly indicated. For example, the tab may be displayed in a low-intensity fashion, a reverse fashion, or in a different color. In the example described above, the tab is deleted and the selection of the tab is disabled. Alternatively, only the explicit indication of the fact that the search item has no keyword may be performed, and the tab may be maintained enabled. In this case, when this tab is selected, no keyword is displayed in the keyword field 421 because the search item has no keyword.

Next, the information process controller 20 determines which tab should be displayed in a highest level (step 173). In the present example, when keywords of respective search items are displayed for the first time, that is, when a first search character is input, the name tab 421a is set to be in the highest level by default. Thereafter, if a tab is selected, this tab is set to be in the highest level and is maintained in the highest level until another tab is selected or another search character is newly input (until a keyword is selected or a next word is selected).

Next, the information process controller 20 displays keywords of the search item corresponding to the tab set to be in the highest level in the keyword field 421 of this tab in the form of keys usable to select a keyword (see FIG. 3) (step 174). That is, keywords that partly match the input character(s) or the selected keyword are extracted as a result of the narrowing and displayed in the keyword field 421 in the form of keys. In a case where the number of keywords extracted as the result of the narrowing is smaller than a predetermined value, keywords related to the extracted keywords may also be displayed.

In this step 174, when the information process controller 20 displays the keywords obtained as the result of the narrowing down in the keyword field 421, the information process controller 20 changes the priority of each keyword according to the present situation (in terms of the season, the weather, the time, the type, the area, etc.), and the information process controller 20 displays the keywords in the keyword field 421 in the descending order of the resultant changed priority. Note that the displaying of the keywords in the form of keys refers to displaying of the keywords such that the displayed keywords are selectable. Specifically, in the present example, the information process controller 20 monitors whether the touch panel is pressed (touched) at a position corresponding to one of the displayed keywords. If touching is detected, the information process controller 20 determines that a keyword at the touched position has been selected.

Next, the information process controller 20 determines whether one of the tabs 421a to 421c has been selected (touched) (step 175). If it is determined that no tab has been selected (No in step 175), the processing flow returns to the destination setting method shown in FIG. 5. When it is determined that one of the tabs 421a to 421c has been selected (Yes in step 421), the information process controller 20 displays the selected tab in the highest level and displays the keywords of the corresponding search item in the form of keys (step 176). Thereafter, the processing flow returns to the destination setting method shown in FIG. 5.

Referring again to FIG. 5, after the displaying of the keywords in the form of keys (step 17), the information process controller 20 monitors the occurrence of next inputting (selection) (steps 18, 20, and 21). If one of the keywords displayed in the keyword field 421 is selected (Yes in step 18), the information process controller 20 replaces the input characters displayed in the input character field 423 with the selected keyword (step 19). In this case, if another keyword has already been displayed in the input character field 423 as a result of a previous operation, this keyword is replaced with the newly selected keyword. In order to distinguish the keyword from the input characters, the keyword is displayed in the input character field 423 in a form enclosed, e.g., in a circle or box.

After the displaying of the selected keyword in the input character field 423, the information process controller 20 returns the process to step 15 to repeat the narrowing of the selected keywords (step 15) and the narrowing of the candidate destination points (step 16). In step 15 after step 19, the keyword narrowing is performed for the keywords obtained as a result of the previous narrowing process (in step 15 after step 14) and stored in the RAM 24 to obtain keywords including the selected keyword. Keywords that are not included in the extracted keywords are discarded.

For example, in a state in which keywords “Tsukuba,” “Tsuchiura,” “Tsuruoka,” and “tourist” are displayed in the keyword field 421 of the name tab 421a, if the keyword “Tsukuba” is selected, then keywords including the selected keyword “Tsukuba,” i.e., “Tsukuba” and “Tsukuba University” are extracted, and the other keywords “Tsuruoka,” “tourist,” etc. are deleted from the RAM 24.

Subsequently, the information process controller 20 narrows down the candidate destination points stored in the RAM 24 according to the selected keyword (step 16). Specifically, the information process controller 20 narrows down the candidate destination points by including the selected keyword in the search characters. In this case, the narrowing is performed for the search item corresponding to the tab of the selected keyword, and the other search items are deleted without being subjected to the narrowing process. In the example described above, the phonetic spelling “tsukuba” (expressed in Japanese kana characters) of the selected keyword “Tsukuba” (expressed in Japanese kanji characters) is employed as the search characters, and the narrowing is performed for the candidate destination points which correspond to the search item “name” and which are stored in the RAM 24, while the candidate destination points corresponding to the other search items “address” and the “type” are deleted from the RAM 24. Subsequently, the information process controller 20 narrows down the candidate destination points according to the narrowed keywords (“Tsukuba” and “Tsukuba University in the above-described example). In this narrowing process, as in the process according to the search characters, the narrowing is performed for the search item corresponding to the tab of the selected keyword. After the narrowing of the candidate destination points (step 16), the keywords obtained as a result of the narrowing in step 15 are displayed in the form of keys (step 17).

In a case where no keyword is selected (No in step 18), but the next word key 428 is selected (Yes in step 20), the information process controller 20 fixes the characters displayed in the input character field 423 (excluding the selected keyword and other already fixed search character strings) as the final search character string. The processing flow then returns to step 13 to monitor the occurrence of inputting a character as a next search character/character string. As a result of the determination of the final search characters, the candidate destination points (destination data) sequentially narrowed down in step 16 in accordance with the search characters and stored in the RAM 24 are determined as final candidate destination points corresponding to the final search characters.

In a case where no keyword is selected and the next word key 428 is not pressed (No in step 18 and No in step 20), but a character is input (No in step 21), then the information process controller 20 returns the process to step 14 to repeat the process from step 14 to display the input character. Note that in this state, the input characters displayed in the input character field 423 are not yet determined as the final search characters.

In a case where the enter key 427 is selected (Yes in step 21), the information process controller 20 determines final candidate destination points from the candidate destination points (destination data) narrowed in step 16 and stored for respective keywords and for respective search character strings in the RAM 24. Specifically, candidate destination points are narrowed down in step 16 each time a keyword is selected (Yes in step 18) and each time a final search character string is determined (Yes in step 20), and the resultant candidate destination points are stored in the RAM 24 separately for the respective keywords and search character strings. The information process controller 20 extracts, from the data stored in the RAM 24, destination data that include for all items corresponding to the keywords and the search character strings, by determining the logical AND of the destination data of the candidate destination points, thereby determining the final candidate destination points (step 22).

The destination data are displayed as final candidate destination points in the form of a list on the display 42 (step 23). In the displaying of the destination data as the candidate destination points, highest priority is given to destination data having keywords. Among destination data having keywords, the destination data are displayed in the descending order of priority assigned to the keywords. The priority may be determined in various manners. For example, the priority may be determined in accordance with the alphabetically order or the order of the Japanese syllabary, in the order of locations starting from the closest to the current position to the farthest, or in the order of parameters selected by a user.

Thereafter, if the user selects one of the candidate destination points displayed on the display 42, then the information process controller 20 sets the selected candidate destination point as a destination (step 24), and the information process controller 20 stores the corresponding destination data in a predetermined storage area of the RAM 24. Thus, the method is completed.

The state of the display screen changes with the progress of the above-described destination setting process according to the present example, as described below with reference to FIGS. 7A to 7H. On the destination setting screen shown in FIG. 4, if a character “TSU” (actually, a corresponding one of Japanese kana characters) is input via the input keyboard 422 (Yes in step 13), then a character “TSU” is shown in the input character field 423 as shown in FIG. 7A (step 14). Keywords that partially match the input character “TSU” are extracted for each of the search items “name,” “address,” and “type” (step 15). For example, for the search item of name, keywords (names) “Tsukuba,” “Tsuchiura,” “Tsuruoka,” “tourist” (including “TSU” when expressed in Japanese kana characters), etc., that partially match the input character “TSU” are extracted.

The input character “TSU” is employed as a search character, and destination data are narrowed down according to the search character for each of the search items, name, address, and type. The destination data are further narrowed down according to each keyword for each of the search items (step 16).

The keywords obtained as a result of the narrowing are displayed in the form of keys (step 17). In this specific case, the input character is a first input character, and thus the name tab 421a is set to be in the highest by default (step 173), and “Tsukuba,” “Tsuchiura,” “Tsuruoka,” “tourist,” and so on expressed in Japanese kanji characters corresponding to the keywords (names) of “Tsukuba,” “Tsuchiura,” “Tsuruoka,” “tourist,” etc. expressed in Japanese kana characters are displayed in the keyword field 421 of the name tab 421a (step 174). Herein, it is assumed that there are keywords including, as part, the input character “TSU” for all search items of name, address, and type.

In FIGS. 7A to 7H, a hand-like symbol h represents a key or button touched by a user. In FIG. 7A, if a keyword “Tsukuba” displayed in the keyword field 421 of the name tab 421a is selected (Yes in step 18), then as shown in FIG. 7B, the selected keyword “Tsukuba” is displayed in the Japanese kanji characters in the input character field 423 (step 19). The keywords are then narrowed down according to this selected keyword (step 15), and then the candidate destination points are narrowed down (step 16). In the input character field 423, in order to distinguish from unfixed characters in the middle of being input, the keywords and the fixed search strings are each displayed in an elliptic frame (keywords or search character string) or a rectangular frame (related keywords).

If “Tsukuba” is selected, a keyword “Tsukuba University” including “Tsukuba” and related keywords “center” and “gakuen” are displayed in the keyword field 421 as shown in FIG. 7B. The keywords and the related keywords displayed in the keyword field 421 are distinguishable, because each keyword is displayed in an elliptic frame while each related keyword is displayed in a rectangular frame.

In the state shown in FIG. 7B, if a character “I” (actually a corresponding one of Japanese kana characters) is selected (No in step 18, No in step 20, and No in step 21), then as shown in FIG. 7C, the input character “I” is displayed in the input character field 423 (step 14). In this specific case, the keyword “Tsukuba” has already been selected and is displayed as an already-selected keyword in the input character field 423. Thus, the newly input character “I” is displayed at a position following the keyword “Tsukuba” in the input character field 423. Keywords partially matching the input character “I” are newly extracted for each of the search items, and extracted keywords “Ichiri,” “imitation,” etc. of the search item of name are displayed in the keyword field 421 of the name tab 421a because the name tab 421a is set to be in the highest level by default (FIG. 7C).

On the setting screen shown in FIG. 7C, if a character “MI” (actually, a corresponding one of Japanese kana characters) is further input, then the keywords obtained above as a result of the narrowing according to the input character “I” are further narrowed down according to an input character string “IMI” (step 15). In this specific example, as shown in FIG. 7D, keywords “imitation,” “Imino,” etc. are extracted for the search item of name and displayed in the keyword field 421, because the name tab 421a is in the highest level. On the other hand, no keywords including “IMI” are detected for the search items of address and type, and thus the address tab 421b and the type tab 421c are deleted.

On the setting screen shown in FIG. 7D, if not one of the keywords displayed in the keyword field 421 but the next word key 428 is selected (Yes in step 20), then the input characters “IMI” displayed in the input character field 423 are fixed as a complete search character string. The characters “IMI” displayed in an unenclosed manner in the input character field 423 are enclosed in an elliptic frame when they are fixed, in order to explicitly indicate that they have been fixed. The shape of the frame use for the above purpose is not limited to the ellipse, but other shapes may be used, or a particular color may be used.

On the setting screen shown in FIG. 7C, if the address tab 421b is selected (touched) (Yes in step 175), then as shown in FIG. 7E, the selected address tab 421b is set to be in the highest level, and keywords associated with the address extracted as a result of the narrowing according to the input character “I” are displayed in the keyword field 421 (step 176).

Thereafter, on the setting screen shown in FIG. 7E, if “Ibaraki-ken” is selected as a keyword of the search item of address, and a next character “KA” (one of Japanese kana characters) is input, then, as shown in FIG. 7F, the keyword “Ibaraki-ken” is displayed next to the already selected keyword “Tsukuba” in the input character field 423, and the input character “KA” is displayed next to the keyword “Ibaraki-ken.” Furthermore, as shown in FIG. 7F, keywords “Kaijin,” “Kawasaki,” “Gakuen-mae,” “Cafe,” etc., obtained as a result of the narrowing are displayed in the keyword field 421 of the name tab 421a being currently in the highest level.

On the setting screen shown in FIG. 7F, if the type tab 421c is selected, then as shown in FIG. 7G, the selected type tab 421c is set to be in the highest level, and keywords “school,” “shopping,” “rental,” “karaoke,” etc., which have already been extracted for the search item of type are displayed in the keyword field 421. In this state, if the keyword “school” is selected, then as shown in FIG. 7H, the selected keyword “school” is displayed in the input character field 423. In a case where when the keyword “school” is selected, if there are no keywords and no related keywords extracted via the narrowing based on the selected keyword “school,” no keywords are displayed in the keyword field 421 as shown in FIG. 7H.

As shown in FIG. 7H, in a state in which a plurality of keywords are selected, if the enter key 427 is selected (Yes in step 21), the logical AND is determined for the candidate destination points narrowed according to the respective selected keywords thereby to determine the final candidate destination points included in all candidate destination point (step 22). On the setting screen shown in FIG. 7D being in the state in which the keyword “Tsukuba” has been selected, and characters “I” and “MI” have been input, if the enter key 427 is selected, then the input characters “IMI” are fixed as a complete search character string, as in the case where the next word key 428 is selected. Destination data included in the candidate destination points extracted for the keyword “Tsukuba” and the candidate destination points extracted for the fixed search character string “IMI” (note that the candidate destination points are extracted for all selected items) are determined as final candidate destination points.

In the above example, each time a search character is input, destination data is narrowed down for each search item. The resultant destination data obtained as a result of the narrowing down process for each search item is stored in association with the corresponding search character strings. Thereafter, destination data, which are included in common for all search character strings, are extracted (by performing a logical AND operation), and resultant destination data are displayed as destination candidates. Thus, the searching can be accomplished simply by inputting information user thinks of in an arbitrary order with no concern for as to whether the information is of a name, type, or address. For example, when searching is performed based on uncertain memory such as “a store whose name is probably “Hana,” which is in a type of a fast food shop, and which is located in Tokyo,” it is not necessary to input data separately for each search item, such as “Hana” as a name, “Tokyo” as a location, and “fast food shop” as a type, but it is sufficient to simply input “Tokyo,” “fast food shop,” and “Hana” as search character strings in an arbitrary order.

Furthermore, in the above example, keywords are used to assist in inputting search characters thereby allowing the search characters to be input in a highly efficient manner. Specifically, in view of the fact that words subjected to the search in the navigation apparatus are limited to particular ones (such as names of locations), one or more words partially identical to a plurality of destination data are extracted as keywords and stored in a keyword data file. The keywords for use in the search are produced by extracting words that are included in common in the destination data, and resultant keywords are stored as keyword data. For example, “supermarket,” “university,” “information,” “center,” “land,” “band,” “amusement park,” “golf,” etc., each appearing as part in a plurality of location names are extracted as keywords. Note that in a case of an apparatus designed for use with the Japanese language, search characters are input using Japanese phonetic characters called kana characters, and kana-expressed words partially identical to the input search characters are extracted as keywords. A keyword for use in the search is assigned to each destination data subjected to the search process.

The keywords are produced for the respective search items (the destination name, the address, and the type) and stored distinguishably in the keyword data file. In the assigning of keywords to the destination data, the keywords are assigned for each of search items (the destination name, the address, and the type).

In the destination search, one or more keywords that partially match the input characters are retrieved, and keywords found as a result of the retrieval are displayed in the form of keyword selection keys so that a user can select a keyword simply by pressing one of the keys. For example, in a simplest case, only by inputting one character and selecting a key, it is possible to select a keyword (which may include three or more characters). Thus, a simplification of the inputting operation is achieved. In the present example, the partial matching is used in the search. Alternatively, forward matching may be employed in the search.

Based on the input search character string, the destination data are narrowed down for each search item, and destination data including any of narrowed-down keywords are extracted. The logical OR (or the logical AND) of the narrowed-down data is determined and stored as candidate destination points. In a case where a keyword is selected, the narrowing down is performed only for a search item corresponding to the selected keyword such that the destination data are narrowed down using the selected keyword as a search character thereby to extract destination data including the selected keyword.

For each keyword stored in the keyword data file, keywords associated therewith are stored as related keywords thereby to make it possible to extract destination candidates based on words that are not included in the name, the address, or the type of destinations.

As described above, by providing keywords or related keywords based on the input character string for use in the destination search, it becomes possible to simplify the input operation and it also becomes possible to easily perform the search for a wide variety of destination candidates. Furthermore, by producing a keyword dictionary from navigation point information, it becomes possible to obtain very proper keywords for use in the destination search in the navigation.

Note that there can be various modifications to the example described above. For example, although in the example described above, keywords including an input character are used to make it possible to input a search character string in a highly efficient manner, it is not necessarily needed to use keywords. In the case where no keywords are used, step 15 and steps 17 to 19 in the destination setting process (FIG. 5) are not necessary. In this case, in step 16, destination data are narrowed down based on the input character string (in an unfixed state) for each of the search items (name, address, and type). Thereafter, as in the example described above, the search character strings are fixed when the next word key 428 or the enter key 427 is selected. The narrowing is performed in step 16 each time a search character is input, and destination data included in any candidate destination points of each search item are extracted from the destination data stored in the RAM 24 and determined as candidate destination point for the fixed search character string. When the enter key 427 is pressed, destination data included for all search items are extracted (by the logical AND operation) and determined as final candidate destination points.

In the example described above, keywords are displayed separately for each of the tabs 421a, 421b, and 421c corresponding to the respective search items, and a search item is selected when a keyword of the search item is selected. In the case where there is no keyword for a particular search item, the corresponding tab is deleted to explicitly indicate the fact that there is no keyword. In contrast, when no keywords are used, the destination setting screen may additionally include search item selection keys (a name key, an address key, and a type key) for selecting the respective search items. The narrowing is sequentially performed each time a character is input separately for each of the search items. If no destination data is detected for a particular search item, a corresponding search item selection key is deleted to explicitly indicate the fact that there is no destination data.

In the example described above, three search items, i.e., name, address, and type are used. Alternatively, any two of them or four or more search items may be employed. In the example described above, keywords are stored in destination data. Alternatively, an ID may be assigned to each keyword in the keyword data file 58, and IDs may be stored in the destination data.

In the above example, it is assumed that the navigation apparatus is designed for use in Japan. Specifically, in the first example, the input keyboard 422 is configured so as to include Japanese syllabary keys for inputting respective Japanese phonetic characters (kana characters), and data used in searching for destination points in Japan are stored in the destination data file 56. However, use of the navigation apparatus is not necessary limited to Japan. By properly modifying the input apparatus 41 and the data depending on an area, it becomes possible to use the input apparatus 41 in a country other than Japan.

Thus, in a second example described below, by way of example, a navigation apparatus adapted to be used in the USA is disclosed. In this second example of the navigation apparatus, the system configuration, the data format, and the destination setting process thereof are basically similar to those according to the first example described above. Thus, in the second example, similar parts to those in the first example are denoted by similar reference numerals, and duplicated explanations thereof are omitted. That is, the following explanation will focus on differences.

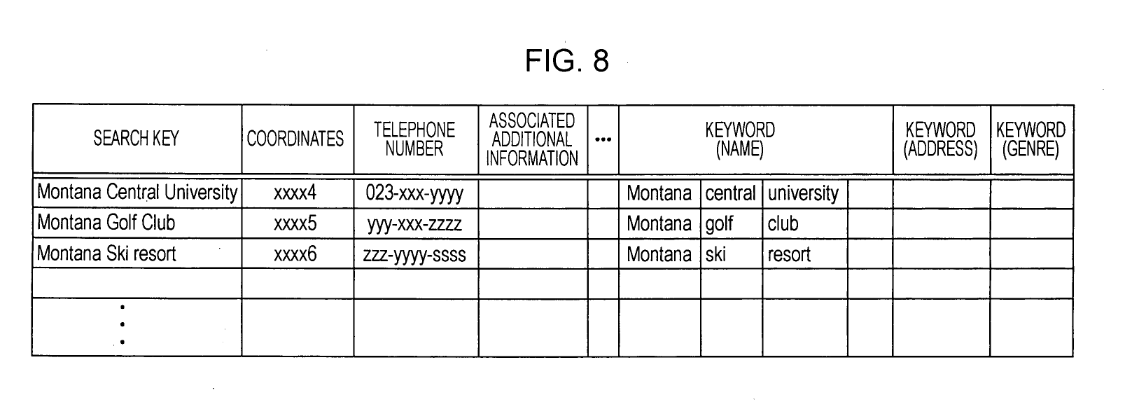

FIG. 8 is a diagram illustrating an example of content of destination data (location information) stored in the destination data file 56. As shown in FIG. 8, in the case of the navigation apparatus for use in the USA, names of destination data are directly registered as search keys. In the search keys for use in the USA, unlike those for use in Japan, words are delimited with a space. The “name” of a destination is used as a search key as described above, and the input apparatus (the alphabetic keys of the touch panel, in the present example) is adapted to input such a search key. The search key can be a mixture of uppercase and lowercase letters. However, differences in lower/upper case are neglected in the search. In the second example, names of destination data in the USA are stored in the destination data file 56.

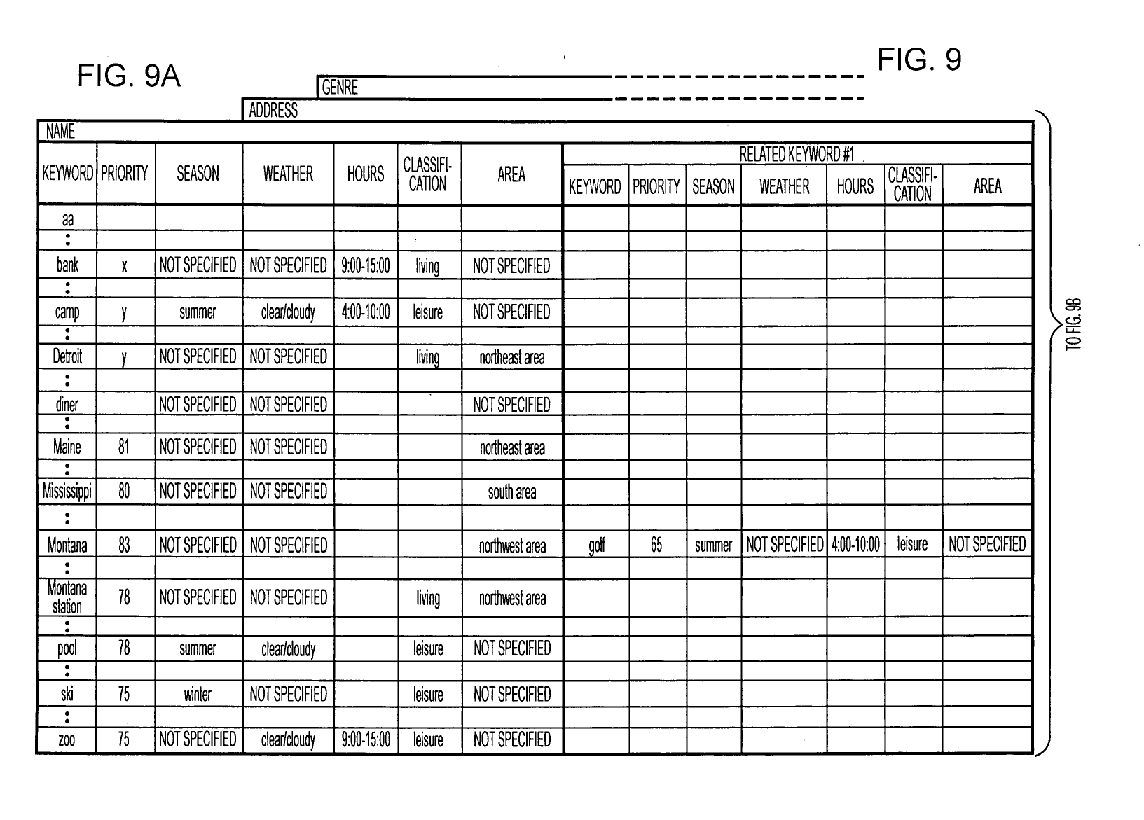

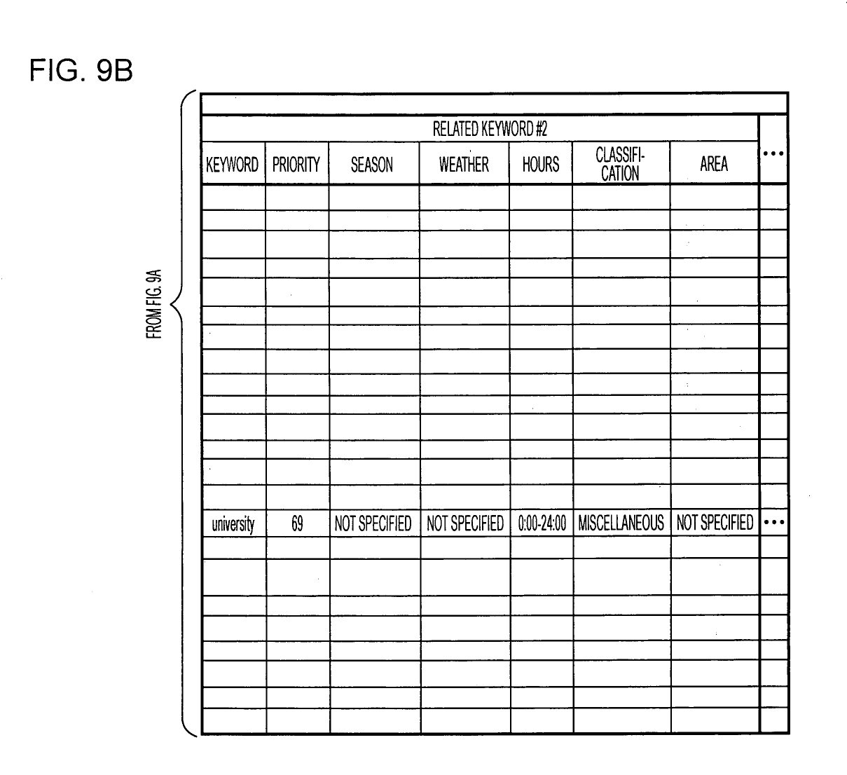

FIGS. 9A and 9B show examples of keywords stored in the keyword data file 58. Each keyword includes one or more words indicating a name of particular destination data. As shown in FIGS. 9A and 9B, also in the navigation apparatus designed for use in the USA as in the navigation apparatus according to the first example, priority is defined for each keyword expressed in a string of alphabetic characters. For example, a candidate destination including a keyword “Montana” is assigned priority of “83,” and the area thereof is defined as “northwest area.” Therefore, if the current position is in the northwest area, a predetermined value (for example, 3) is added to the priority of 83, and thus the priority is changed to 86. For some keywords, related keywords are defined. A word having a high probability of being input together with a keyword is employed as a related keyword for this keyword. For example, when “golf” and “university” are part of the name of a destination having an assigned keyword “Montana,” then “golf” and “university” are employed as related keywords.

In the keyword data file 58, available seasonal periods are defined depending on the country or the area in which the navigation apparatus is used. For example, the navigation apparatus is used in Japan, a period from December to February is defined as winter. On the other hand, in Australia located in the southern hemisphere, a period from June to August is defined as winter. Similarly, available time zones defined in the keyword data file 58 depend on the country or the area in which the navigation apparatus is used. For example, in countries or areas having a summer time system, available time zones are moved up by 1 hour during a summer-time period.

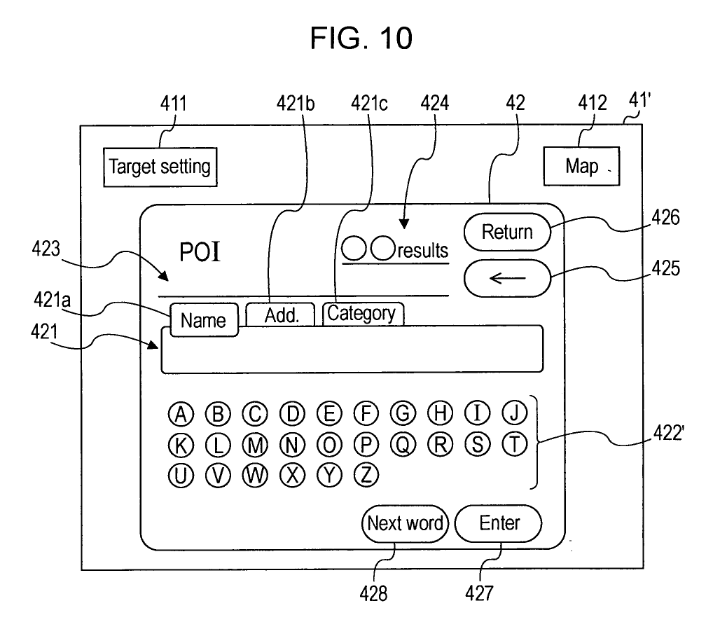

FIG. 10 is a schematic diagram illustrating an input apparatus 41′ and a display 42 of a navigation apparatus designed for use in the USA. In FIG. 10 showing the navigation apparatus for use in the USA, similar parts to those of the navigation apparatus according to the first example (FIG. 4) are denoted by similar reference numerals. As shown in FIG. 10, an input keyboard 422′ includes a plurality of keys for inputting alphabetic characters A to Z.

In this navigation apparatus including the input apparatus 41′ designed for use in the USA, the destination setting process and the process of displaying keywords in the form of keys are performed in a similar manner to the first example described above (FIGS. 5 and 6) except that in this second example, an alphabetic character string is input using the input keyboard 422′, and the destination data file 56 and the keyword data file 58 which are referred to in the process include data for use in the USA.

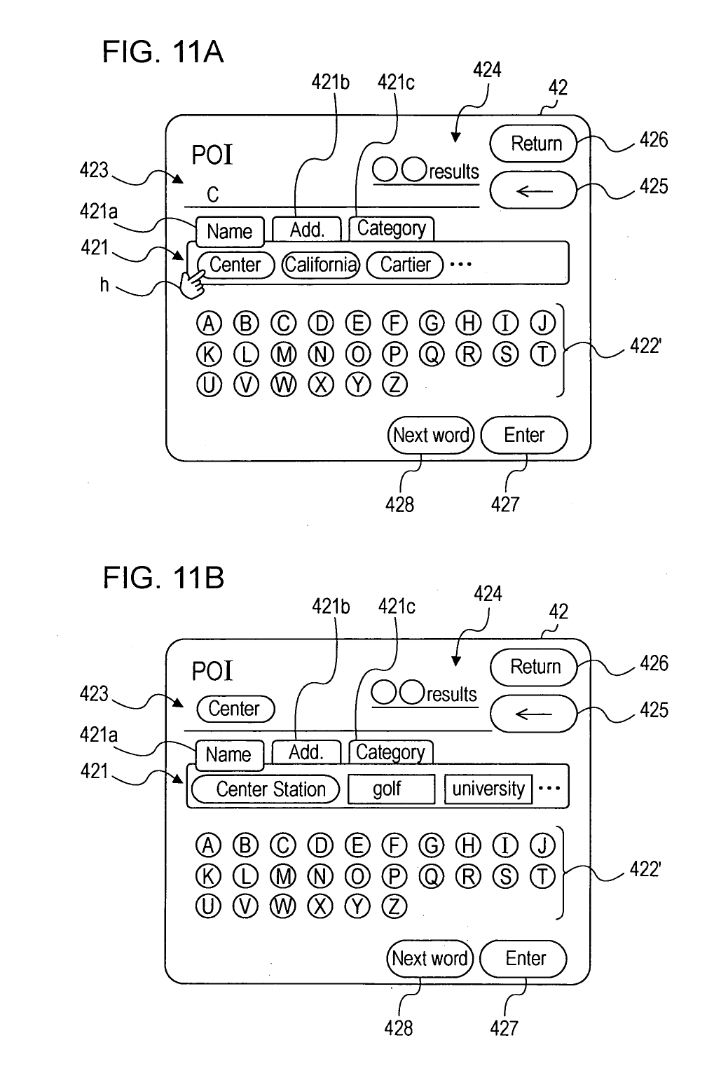

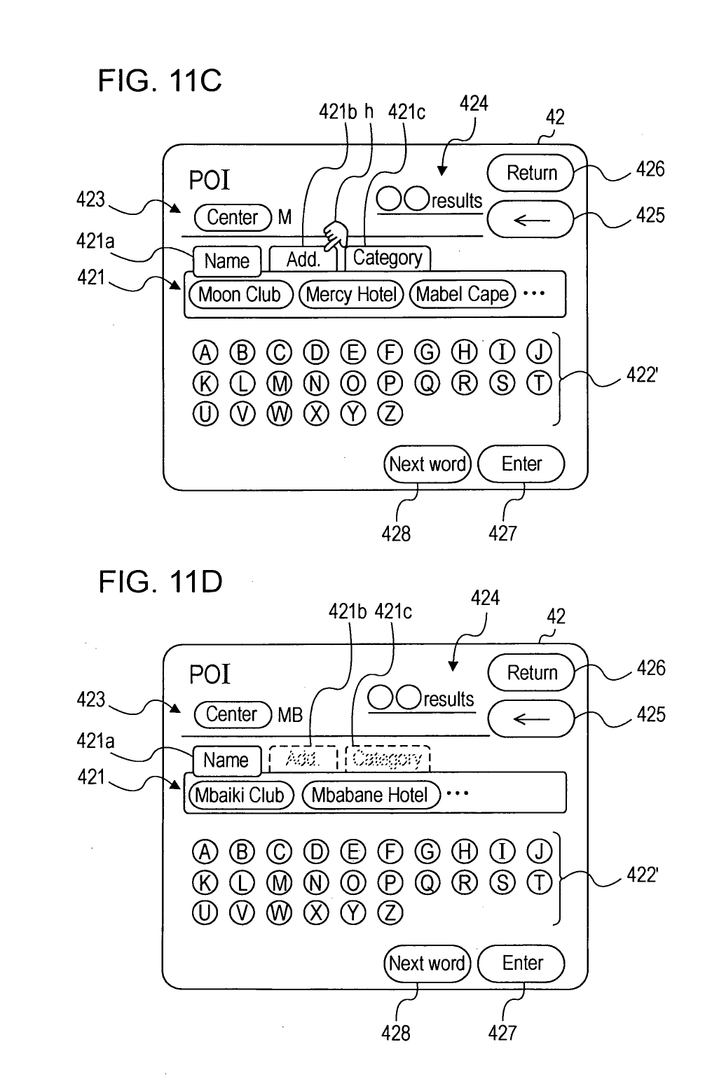

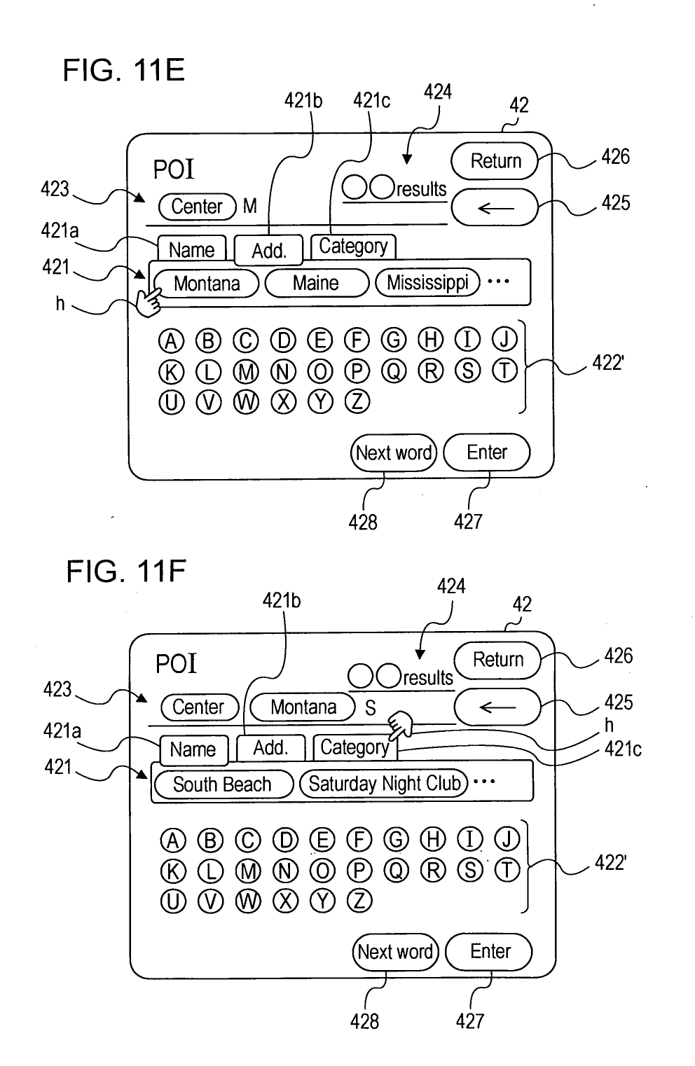

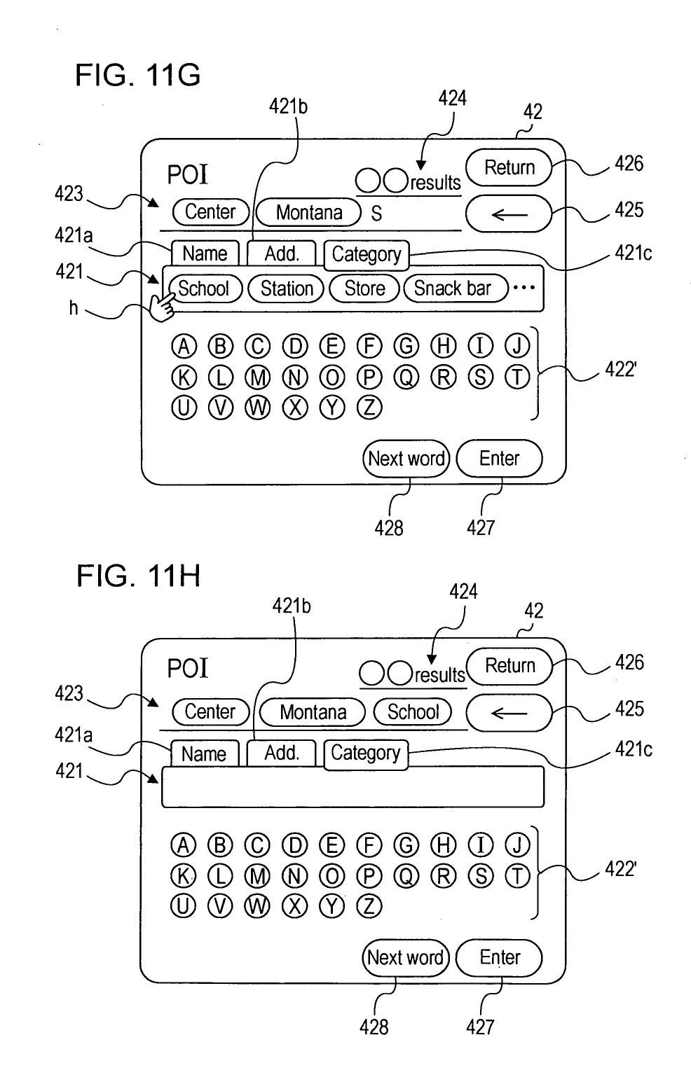

In the navigation apparatus adapted for use in the USA, the state of the display screen changes with the progress of the destination setting process, as described below with reference to FIGS. 11A to 11H. On the destination setting screen shown in FIG. 10, if an alphabetic character “C” is input via an input keyboard 422′, then as shown in FIG. 11A, “C” is displayed in the input character field 423. The input character “C” is employed as a search character, and destination data are narrowed down according to the search character for each of the search items, name, address, and type. The destination data are further narrowed down according to each keyword for each of the search items, and the keywords obtained as a result of the narrowing are displayed in the form of keys. In this specific example, the input character is a first input character, and thus the name tab 421a is set to be in the highest by default, and extracted keywords (names) “Center,” “California,” “Cartier,” etc. are displayed in the keyword field 421 of the name tab 421a. Herein, it is assumed that there are keywords including, as part, the input character “C” for all search items of name, address, and type.

In FIGS. 11A to 11H, a hand-like symbol h represents a key or button touched by a user. As shown in FIG. 11A, if the keyword “Center” displayed in the keyword field 421 of the name tab 421a is selected, then as shown in FIG. 11B, the selected keyword “Center” is displayed in the input character field 423. The keywords are then narrowed down according to this selected keyword, and then the candidate destination points are narrowed down. If “Center” is selected, a keyword “Center Station” including “Center” and keywords “golf” and “university” related to “Center” are displayed in the keyword field 421 as shown in FIG. 11B.

In the state shown in FIG. 11B, if a character “M” is further input, then as shown in FIG. 11C, the input character “M” is displayed in the input character field 423. In this specific case, the keyword “Center” has already been selected and is displayed as an already-selected keyword in the input character field 423. Thus, the newly input character “M” is displayed at a position following the keyword “Center” in the input character field 423. Keywords partially matching the input character “M” are newly extracted for each of the search items, and extracted keywords “Moon Club,” “Mercy Hotel,” “Mabel Cape,” etc. of the search item of name are displayed in the keyword field 421 of the name tab 421a, because the name tab 421a is currently in the highest level.

On the setting screen shown in FIG. 11C, if a character “B” is further input, then the keywords obtained above as a result of the narrowing according to the input character “M” are further narrowed down according to a character string “MB.” In this specific case, as shown in FIG. 11D, keywords “Mbaiki Club,” “Mbabane Hotel,” etc. are extracted for the search item of name and displayed in the keyword field 421. On the other hand, no keywords including “MB” are detected for the search items of address and type, and thus the address tab 421b and the type (category) tab 421c are deleted.

On the setting screen shown in FIG. 11D, if one of the keywords displayed in the keyword field 421 is not selected but the next word key 428 is selected, then the input characters “MB” displayed in the input character field 423 are fixed as a complete search character string. The characters “MB” displayed in an unenclosed manner in the input character field 423 are enclosed in an elliptic frame when they are fixed, in order to explicitly indicate that they have been fixed. The shape of the frame use for the above purpose is not limited to the ellipse, but other shapes may be used, or a particular color may be used.

On the setting screen shown in FIG. 11C, if the address tab 421b is selected (touched), then as shown in FIG. 11E, the selected address tab 421b is set to be in the highest level, and keywords associated with the address extracted as a result of the narrowing according to the input character “M” are displayed in the keyword field 421. Thereafter, on the setting screen shown in FIG. 11E, if “Montana” is selected as a keyword of the search item of address, and a next character “S” is input, then, as shown in FIG. 11F, the keyword “Montana” is displayed next to the already selected keyword “Center” in the input character field 423, and the input character “S” is displayed next to the keyword “Montana.” In this state, if the name tab 421a is selected, then as shown in FIG. 11F, keywords “South Beach,” “Saturday Night Club,” etc., obtained as a result of the narrowing are displayed in the keyword field 421 of the name tab 421a being currently in the highest level.

On the setting screen shown in FIG. 11F, if the type tab 421c is selected, then as shown in FIG. 11G, the selected type tab 421c is set to be in the highest level, and keywords “school,” “station,” “store,” “snack bar,” etc., which have already been extracted for the search item of type are displayed in the keyword field 421. In this state, if the keyword “school” is selected, then as shown in FIG. 11H, the selected keyword “school” is displayed in the input character field 423. If there are no keywords and no related keywords extracted via the narrowing based on the selected keyword “school,” no keywords are displayed in the keyword field 421 as shown in FIG. 11H.

As shown in FIG. 11H, in a state in which a plurality of keywords are selected, if the enter key 427 is selected, the logical AND is determined for the candidate destination points narrowed according to the respective selected keywords thereby to determine the final candidate destination points included in all candidate destination point On the setting screen shown in FIG. 11D being in the state in which the keyword “Center” has been selected, and characters “M” and “B” have been input, if the enter key 427 is selected, then the input characters “MB” are fixed as a complete search character string, as in the case where the next word key 428 is selected. Destination data included in the candidate destination points extracted for the keyword “Center” and the candidate destination points extracted for the fixed search character string “MB” (note that the candidate destination points are extracted for all selected items) are determined as final candidate destination points.

The manner of displaying a selected keyword in the input character field 423 may be changed depending on the tab (the search item) referred to when the keyword is selected. For example, keywords may be displayed in different colors depending on the tabs (search items) such that keywords selected from the name tab 421a are displayed in red, keywords selected from the address tab 421b are displayed in yellow, and keywords selected from the type tab 421c are displayed in blue. The colors may be set in any desirable manner. The technique of changing colors in which keywords are displayed may be applied to the navigation apparatus for use in Japan according to the first example. By changing the manner of displaying keywords depending on the tabs (search items), it becomes possible for a user to visually recognize the types of tabs from which keywords were selected, even after the keywords were selected.

Also in the navigation apparatus, for use in the USA, with the input character field 423 adapted to input an alphabetic character string, as with the navigation apparatus according to the first example described above, the searching can be accomplished simply by inputting information a user thinks of in an arbitrary order with no concern for as to whether the information is of a name, type, or address.

In the second example described above, the navigation apparatus is configured so as to include alphabet keys for inputting English words. However, the language is not limited to English, but the navigation apparatus may be configured so as to use various other languages such as German, Spanish, French, Arabic, Chinese, Korean, Russian, etc. For example, in the case of a navigation apparatus for use in China, the input apparatus 41 includes an input keyboard 422 adapted for inputting Chinese pinyin characters.

The language does not necessarily need to correspond to the country (area) where the navigation apparatus is used. For example, a navigation apparatus adapted to operate using German may be configured so as to be usable in France. In this case, the data stored in the destination data file 56 or the keyword data file 58 for use in the destination search, i.e., the data which are compared with the input character string (for example, the name of the destination, the keywords, the address, etc.) are described in the same language as the input language and in a format adapted to the input language. The data subjected to the search does not necessarily need to be described in the same language as the language spoken in the country (area) where the navigation apparatus is used. The data that are not subjected to the destination search, such as the appended information data, do not necessarily need to be described in the same language as the input language. That is, the data which are not subjected to the destination search may be described in the same language as the input language or may be described in the same language as the language spoken in the country (area) where the navigation apparatus is used, or may be described using both languages.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A navigation apparatus, comprising:
a memory that stores a plurality of destinations, each destination being associated with a plurality of types of search items; and
a controller configured to:
input a first search character;
retrieve the destinations in which the input search character exists in one of the associated search items;
temporarily store the retrieved destinations in association with the search item in which the input character exists;
input a second search character;
narrow down the temporarily stored destinations by deleting the temporarily stored destinations in which the second search character does not exist in any of the associated search items;
display the narrowed down destinations as candidate destinations;
permit selection of one of the displayed candidate destinations; and
provide route guidance to the selected destination.

2. The navigation apparatus according to claim 1, wherein the controller is configured to:
explicitly indicate a search item in which the first and second characters are not associated with any destination.

3. The navigation apparatus according to claim 1, wherein:
the first and the second input characters form a character string; and
the controller is configured to:
permit selection of a search item; and
if a search item is selected, identify the temporarily stored destinations in which the character string is included in the selected search item.

4. The navigation apparatus according to claim 1, wherein:
for each destination, the memory stores at least one keyword for each search item; and
the controller is configured to:
extract keywords including the input first search character for each of the plurality of search items;
display one or more extracted keywords;
permit selection of a displayed keyword; and
if a keyword is selected, narrow down the temporarily stored destinations by deleting the temporarily stored destinations in which the selected keyword does not exist in any of the associated search items.

5. The navigation apparatus according to claim 4, wherein the controller is configured to:
permit selection of a search item; and
display one or more keywords corresponding to the selected search item.

6. The navigation apparatus according to claim 4, wherein the controller is configured to:
narrow down the keywords for each search item each time a character is input as a part of a search character string; and
explicitly indicate a search item for which there are no keywords including the search character string.

7. The navigation apparatus according to claim 6, wherein the controller is configured to explicitly indicate the search item by changing a state in which the explicitly indicated search item is displayed.

8. The navigation apparatus according to claim 1, wherein the plurality of types of search items comprise a destination name, a destination address, and a destination type.

9. A navigation method, comprising:
storing a plurality of destinations, each destination being associated with a plurality of types of search items; and
inputting a first search character;
retrieving the destinations in which the input search character exists in one of the associated search items;
temporarily storing the retrieved destinations in association with the search item in which the input character exists;
inputting a second search character;
narrowing down the temporarily stored destinations by deleting the temporarily stored destinations in which the second search character does not exist in any of the associated search items;
displaying the narrowed down destinations as candidate destinations;
permitting selection of one of the displayed candidate destinations; and
providing route guidance to the selected destination.

10. The navigation method according to claim 9, further comprising:
explicitly indicate a search item in which the first and second characters are not associated with any destination.

11. The navigation method according to claim 9, wherein:
the first and the second input characters form a character string; and
the method further comprises:
permitting selection of a search item; and
if a search item is selected, identifying the temporarily stored destinations in which the character string is included in the selected search item.

12. The navigation method according to claim 9, further comprising:
for each destination, storing at least one keyword for each search item;
extracting keywords including the input first search character for each of the plurality of search items;
displaying one or more extracted keywords;
permitting selection of a displayed keyword; and
if a keyword is selected, narrowing down the temporarily stored destinations by deleting the temporarily stored destinations in which the selected keyword does not exist in any of the associated search items.

13. The navigation method according to claim 12, further comprising:
permitting selection of a search item; and
displaying one or more keywords corresponding to the selected search item.

14. The navigation method according to claim 12, further comprising:
narrowing down the keywords for each search item each time a character is input as a part of a search character string; and
explicitly indicating a search item for which there are no keywords including the search character string.

15. The navigation method according to claim 14, further comprising explicitly indicating the search item by changing a state in which the explicitly indicated search item is displayed.

16. The navigation method according to claim 9, wherein the plurality of types of search items comprise a destination name, a destination address, and a destination type.

17. The navigation method according to claim 9, wherein he method is implemented by a controller.

18. A computer-readable storage medium storing a computer-executable program usable for navigation, the program comprising:
instructions for storing a plurality of destinations, each destination being associated with a plurality of types of search items; and
instructions for inputting a first search character;
instructions for retrieving the destinations in which the input search character exists in one of the associated search items;
instructions for temporarily storing the retrieved destinations in association with the search item in which the input character exists;
instructions for inputting a second search character;
instructions for narrowing down the temporarily stored destinations by deleting the temporarily stored destinations in which the second search character does not exist in any of the associated search items;
instructions for displaying the narrowed down destinations as candidate destinations;
instructions for permitting selection of one of the displayed candidate destinations; and
instructions for providing route guidance to the selected destination.

19. Thee computer-readable storage medium of claim 18, the program further comprising:
instructions for, for each destination, storing at least one keyword for each search item;
instructions for extracting keywords including the input first search character for each of the plurality of search items;
instructions for displaying one or more extracted keywords;
instructions for permitting selection of a displayed keyword; and
instructions for, if a keyword is selected, narrowing down the temporarily stored destinations by deleting the temporarily stored destinations in which the selected keyword does not exist in any of the associated search items.
